(19) United States
(12) Patent Application Publication
(10) Pub. No.: US 2021/0044568 A1
(43) Pub. Date: Feb. 11, 2021

(54) SPECIFYING SYSTEM AND SPECIFYING METHOD

(71) Applicant: NIPPON TELEGRAPH AND TELEPHONE CORPORATION, Tokyo (JP)

(72) Inventors: Tetsuhiko MURATA, Musashino-shi, Tokyo (JP); Shingo KASHIMA, Musashino-shi, Tokyo (JP)

(73) Assignee: NIPPON TELEGRAPH AND TELEPHONE CORPORATION, Tokyo (JP)

(21) Appl. No.: 16/966,477

(22) PCT Filed: Feb. 27, 2019
(86) PCT No.: PCT/JP2019/007704

§ 371 Date: Jul. 31, 2020

(30) Foreign Application Priority Data
Feb. 27, 2018 (JP) 2018-033918

(51) Int. Cl. H04L 29/06; H04L 12/66

(52) U.S. Cl. CPC H04L 63/0245; H04L 63/1425; H04L 12/66; H04L 63/029

(57) ABSTRACT

A gateway device (10) acquires terminal addresses and identification information of a terminal (20). Further, the gateway device (10) forwards an access request packet transmitted from the terminal (20) to a determination device (30), and forwards a response packet transmitted by the determination device (30) to the terminal (20). Then, the determination device (30) determines whether or not the packet forwarded by the gateway device (10) is abnormal, and transmits a response packet indicating the determination result. Further, at the time of transmitting a response packet indicating an abnormality, the gateway device (10) identifies the identification information of the terminal that has transmitted the packet on which the response packet is based.

### TECHNICAL FIELD

The present invention relates to an identification system and an identification method.

### BACKGROUND ART

Conventionally, as a method of detecting an abnormality due to a security breach of a terminal in a network, identifying the terminal determined to be abnormal, and alerting a user, there is known a method using a blacklist of communication destinations such as FQDN (Fully Qualified Domain Name) and URI (Uniform Resource Identifier).

A terminal having been subjected to a security breach such as malware infection attempts to access a malicious communication destination. To address this issue, a server, such as a DNS server or a Web proxy server on the network, holds a blacklist of malicious communication destinations such as FQDN and URI so that the server can detect an abnormality when the terminal attempts to access a malicious communication destination, and identify the terminal having made the access.

For example, there is known a method in which a dedicated plug-in is installed on a Web browser of a terminal to alert the terminal user through a screen pop-up of the browser that has communicated with a malicious communication destination (e.g., see NPL 1). Further, for example, there is known a method in which a communication carrier identifies a user from a source IP address of a DNS query for the FQDN of a malicious communication destination, and alerts the user by e-mail (e.g., see NPL 2).

### CITATION LIST

### Non Patent Literature

[NPL 1] Ministry of Internal Affairs and Communications, etc. “Active malware damage prevention activities”, [online], [retrieved on Feb. 17, 2018], Internet (http://www.active.go.jp/active/damage prevention.html)
[NPL 2] NTT Communications, “Malware Unauthorized Communication Blocking Service”, [online], [retrieved on Feb. 17, 2018], Internet (http://www.ntt.com/personal/ocn-security/info/malware.html)

### SUMMARY OF THE INVENTION

### Technical Problem

However, conventional methods have a problem that it may be difficult to identify a terminal that has caused an abnormality detected in a network. For example, since the method disclosed in NPL 1 uses a Web browser, it is difficult to apply the same method to IoT (Internet of Things) or the like in which browsing with a Web browser is not available. On the other hand, in the method disclosed in NPL 2, when a terminal accesses a DNS server via a gateway device having functions such as NAT (Network Address Translation) and a DNS proxy, and attempts to access a malicious communication destination, the terminal cannot be identified from the source IP address in some cases.

### Means for Solving the Problem

In order to solve the above-described problem and achieve the object, an identification system of the present invention includes a gateway device connected to a first network and a second network, and a determination device connected to the first network. The determination unit includes a determination unit that determines whether an access request packet forwarded by the gateway device is abnormal, and a response unit that transmits a response packet depending on a determination result by the determination unit. The gateway device includes a forwarding unit that forwards, to the determination device, the access request packet transmitted from a terminal in the second network, and forwards, to the terminal, a response packet transmitted by the response unit, an acquisition unit that acquires, on the basis of a packet transmitted from a terminal in the second network, a terminal address and identification information of the terminal in association with each other, and an identification unit that identifies, when the determination unit determines that the access request packet is abnormal, the identification information of the terminal that has transmitted the access request packet on the basis of the response packet transmitted by the response unit and the terminal address, of the terminal that has transmitted the access request packet, acquired by the acquisition unit.

### Effects of the Invention

According to the present invention, it is possible to identify a terminal that has caused an abnormality detected in a network.

### BRIEF DESCRIPTION OF DRAWINGS

FIG. 1 is a diagram illustrating an example of a configuration of an identification system according to a first embodiment.

FIG. 2 is a diagram illustrating an example of a configuration of a gateway device according to the first embodiment.

FIG. 3 is a diagram illustrating an example of terminal information according to the first embodiment.

FIG. 4 is a diagram illustrating an example of a configuration of a determination device according to the first embodiment.

FIG. 5 is a diagram illustrating an example of a configuration of a management device according to the first embodiment.

FIG. 6 is a flowchart illustrating a flow of an uplink forwarding process in the gateway device according to the first embodiment.

FIG. 7 is a flowchart illustrating a flow of a response process in the determination device according to the first embodiment.

FIG. 8 is a flowchart illustrating a flow of a downlink forwarding process in the gateway device according to the first embodiment.

FIG. 9 is a diagram illustrating an example of a configuration of a gateway device according to a second embodiment.

FIG. 10 is a diagram illustrating an example of a configuration of a determination device according to the second embodiment.

FIG. 11 is a flowchart illustrating a flow of an uplink forwarding process in the gateway device according to the second embodiment.

FIG. 12 is a flowchart illustrating a flow of a response process in the determination device according to the second embodiment.

FIG. 13 is a diagram illustrating an example of a configuration of a gateway device according to a third embodiment.

FIG. 14 is a diagram illustrating an example of a configuration of a determination device according to the third embodiment.

FIG. 15 is a diagram illustrating an example of a configuration of a management device according to the third embodiment.

FIG. 16 is a flowchart illustrating a flow of an uplink forwarding process in the gateway device according to the third embodiment.

FIG. 17 is a flowchart illustrating a flow of a response process in the determination device according to the third embodiment.

FIG. 18 is a flowchart illustrating a flow of an identification process in the management device according to the third embodiment.

FIG. 19 is a diagram illustrating an example of a configuration of a management device according to a fourth embodiment.

FIG. 20 is a flowchart illustrating a flow of an uplink forwarding process in a gateway device according to the fourth embodiment.

FIG. 21 is a flowchart illustrating a flow of an identification process in the management device according to the fourth embodiment.

FIG. 22 is a diagram illustrating an example of a computer that functions as a gateway device, a determination device, or a management device to execute an identification program.

### DESCRIPTION OF EMBODIMENTS

Hereinafter, embodiments of an identification system and an identification method according to the present application will be described in detail with reference to the drawings. Note that the present invention is not limited by the embodiments described below.

### First Embodiment

[Configuration of Identification System of First Embodiment]

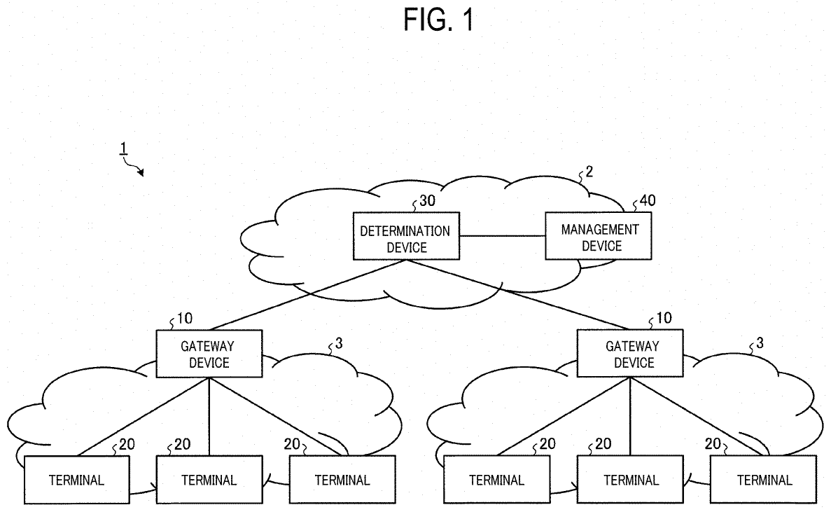

First, a configuration of an identification system according to a first embodiment will be described with reference to FIG. 1. FIG. 1 is a diagram illustrating an example of a configuration of an identification system according to a first embodiment. As illustrated in FIG. 1, an identification system 1 includes a gateway device 10, terminals 20, a determination device 30, and a management device 40.

The gateway device 10 forwards packets between a network 2 and a network 3. The determination device 30 determines whether or not a packet is abnormal. The determination device 30 is, for example, a DNS server that holds a malicious FQDN list as a blacklist. The network 2 is, for example, a public network. Further, the network 3 is, for example, a local network. Further, the network 2 is an example of a first network. Further, the network 3 is an example of a second network.

Further, a plurality of networks 3 may be connected to the network 2. In that case, each of the plurality of networks 3 is provided with the gateway device 10. Further, the number of terminals 20 connected to the gateway device 10 is not limited to the number illustrated.

[Configuration of Gateway Device of First Embodiment]

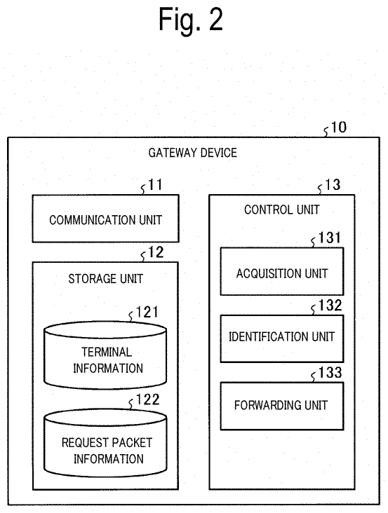

Here, a configuration of the gateway device 10 will be described with reference to FIG. 2. FIG. 2 is a diagram illustrating an example of a configuration of a gateway device according to the first embodiment. As illustrated in FIG. 2, the gateway device 10 includes a communication unit 11, a storage unit 12, and a control unit 13.

The communication unit 11 performs data communication with another device via a network. The communication unit 11 is, for example, an NIC (Network Interface Card). The communication unit 11 can perform communication between a device connected to the network 2 and a device connected to the network 3.

The storage unit 12 is a storage device such as an HDD (Hard Disk Drive), an SSD (Solid State Drive), and an optical disk. Note that the storage unit 12 may be a rewritable semiconductor memory such as a RAM (Random Access Memory), a flash memory, or an NVSRAM (Non-Volatile Static Random Access Memory). The storage unit 12 stores an OS (Operating System) executed by the gateway device 10 and various programs. The storage unit 12 further stores various information used in executing the program. The storage unit 12 also stores terminal information 121 and request packet information 122.

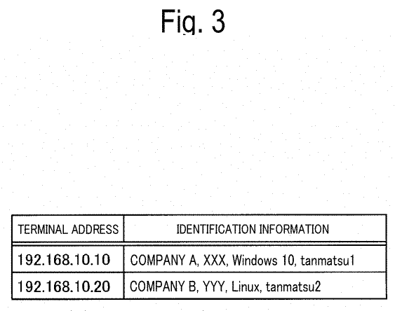

FIG. 3 is a diagram illustrating an example of the terminal information according to the first embodiment. As illustrated in FIG. 3, the terminal information 121 is a set of a terminal address and identification information. Note that the terminal address and the identification information are information acquired by an acquisition unit 131 and the like described later.

The terminal address is an address that can identify the terminal 20. The terminal address is, for example, a local address used in the network 3. Further, the identification information is information for identifying the terminal 20. The identification information includes, for example, hardware information such as a manufacturer, a model, and a model number. Further, the identification information includes, for example, software information such as an OS and firmware. Further, the identification information includes information such as a host name set in the terminal 20.

The request packet information 122 is a source address of an access request packet transmitted from the terminal 20 and forwarded to the network 2. Here, the source address of a packet forwarded to the network 2 may be translated into a predetermined address, unlike the above-described terminal address. The source address of the request packet information 122 is, for example, a global address assigned to the gateway device 10.

The control unit 13 controls the entire gateway device 10. The control unit 13 is, for example, an electronic circuit such as a CPU (Central Processing Unit) and an MPU (Micro Processing Unit), or an integrated circuit such as an ASIC (Application Specific Integrated Circuit) and an FPGA (Field Programmable Gate Array). Further, the control unit 13 includes an internal memory for storing programs defining various processing procedures and control data, and executes each process using the internal memory. Further, the control unit 13 functions as various processing units when various programs are executed. The control unit 13 includes, for example, an acquisition unit 131, an identification unit 132, and a forwarding unit 133.

The acquisition unit 131 acquires, on the basis of a packet transmitted from a terminal 20 in the network 3, the terminal address and the identification information of the terminal 20 in association with each other. The acquisition unit 131 may acquire the terminal address and the identification information on the basis of a response packet to a packet transmitted from the gateway device 10 to the terminal 20, or may acquire the terminal address and the identification information on the basis of a packet transmitted independently by the terminal 20. Further, the acquisition unit 131 may acquire the terminal address and the identification information by using a message of UPnP (Universal Plug and Play) Description transmitted by the terminal 20, or may collate a packet transmitted by the terminal 20 with dictionary data held in advance to acquire the identification information.

The identification unit 132 identifies the identification information of the terminal that has transmitted the access request packet determined to be abnormal. First, when the determination device 30 determines that the access request packet is abnormal, the identification unit 132 identifies the destination address of the response packet transmitted by the determination device 30. Further, the identification unit 132 identifies the identification information of the terminal 20 that has transmitted the access request packet on the basis of the identified destination address and the terminal address of the terminal 20 acquired by the acquisition unit 131.

The forwarding unit 133 forwards the access request packet transmitted from the terminal 20 in the network 3 to the determination device 30. Here, when forwarding the packet to the determination device 30 in the network 2, the forwarding unit 133 translates the source address. In addition, the forwarding unit 133 forwards the response packet transmitted by the determination device 30 to the terminal 20 in the network 3. Here, when forwarding the packet to the terminal 20 in the network 3, the forwarding unit 133 translates the destination address.

For example, when a DNS name resolution request packet is transmitted from the terminal 20, the forwarding unit 133 can perform NAT forwarding that translates the source IP address of the DNS name resolution request packet into the IP address of the network 2 side of the gateway device 10, and then forwards the IP address. Further, for example, even when the gateway device 10 has a DNS proxy function and acts as a proxy for a DNS name resolution request packet addressed to the gateway device 10, the forwarding unit 133 translates the source address of the DNS name resolution request packet. Note that the DNS name resolution request packet is an example of an access request packet.

[Configuration of Determination Device of First Embodiment]

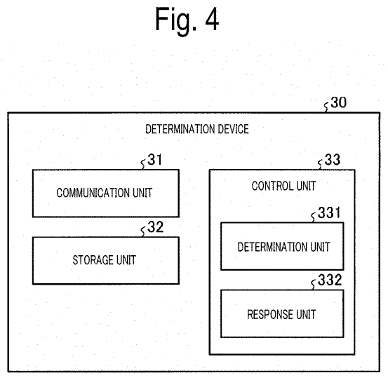

Next, a configuration of the determination device 30 will be described with reference to FIG. 4. FIG. 4 is a diagram illustrating an example of the configuration of the determination device according to the first embodiment. As illustrated in FIG. 4, the determination device 30 includes a communication unit 31, a storage unit 32, and a control unit 33.

The communication unit 31 performs data communication with another device via a network. The communication unit 31 is, for example, an NIC. The communication unit 31 can perform communication with the gateway device 10.

The storage unit 32 is a storage device such as an HDD, an SSD, and an optical disk. Note that the storage unit 32 may be a rewritable semiconductor memory such as a RAM, a flash memory, or an NVSRAM. The storage unit 32 stores an OS executed by the gateway device 10 and various programs. Further, the storage unit 32 stores various information used in executing the program.

The control unit 33 controls the entire determination device 30. The control unit 33 is, for example, an electronic circuit such as a CPU or an MPU, or an integrated circuit such as an ASIC or an FPGA. Further, the control unit 33 includes an internal memory for storing programs defining various processing procedures and control data, and executes each process using the internal memory. Further, the control unit 33 functions as various processing units when various programs are executed. The control unit 33 includes, for example, a determination unit 331 and a response unit 332.

The determination unit 331 determines whether or not the access request packet forwarded by the gateway device 10 is abnormal. The determination unit 331 determines, for example, whether or not the access request packet is abnormal using a blacklist of malicious FQDNs. In this case, if a DNS name resolution request packet is for requesting name resolution for an FQDN included in the blacklist, the determination unit 331 can determine that the DNS name resolution request packet is abnormal.

The response unit 332 transmits a response packet depending on the determination result by the determination unit 331. At this time, when the determination unit 331 determines that the access request packet is not abnormal, the response unit 332 can transmit a name resolution response packet based on the DNS protocol to the source address of the access request packet; and when the determination unit 331 determines that the access request packet is abnormal, the response unit 332 can transmit a specific packet different from the DNS protocol name resolution response packet to the source address of the access request packet as a response packet.

For example, when the determination unit 331 determines that the access request packet is not abnormal, the response unit 332 transmits a response packet including an IP address obtained as a result of the name resolution. On the other hand, when the determination unit 331 determines that the access request packet abnormal, the response unit 332 can transmit a response packet including an IP address not used on the network, such as “127.0.0.1”.

[Configuration of Management Device of First Embodiment]

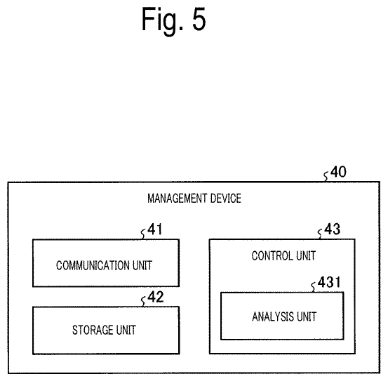

Next, a configuration of the management device 40 will be described with reference to FIG. 5. FIG. 5 is a diagram illustrating an example of a configuration of a management device according to the first embodiment. As illustrated in FIG. 5, the management device 40 includes a communication unit 41, a storage unit 42, and a control unit 43.

The communication unit 41 performs data communication with another device via a network. The communication unit 41 is, for example, an NIC. The communication unit 41 can communicate with the gateway device 10 and the determination device 30.

The storage unit 42 is a storage device such as an HDD, an SSD, and an optical disk. Note that the storage unit 42 may be a rewritable semiconductor memory such as a RAM, a flash memory, or an NVSRAM. The storage unit 42 stores an OS executed by the gateway device 10 and various programs. Further, the storage unit 42 stores various information used in executing the program. The storage unit 42 stores, for example, terminal information 421.

The control unit 43 controls the entire management device 40. The control unit 43 is, for example, an electronic circuit such as a CPU or an MPU, or an integrated circuit such as an ASIC or an FPGA. Further, the control unit 43 includes an internal memory for storing programs defining various processing procedures and control data, and executes each process using the internal memory. Further, the control unit 43 functions as various processing units when various programs are executed. The control unit 43 includes, for example, an analysis unit 431.

The analysis unit 431 analyzes the tendency of the terminal 20 that has transmitted the access request packet determined to be abnormal on the basis of the identification information identified by each gateway device 10. Such an analysis is practicable because the information of terminals 20 that have transmitted an abnormal access request packet can be collected in the identification system 1 as described above.

### Process According to First Embodiment

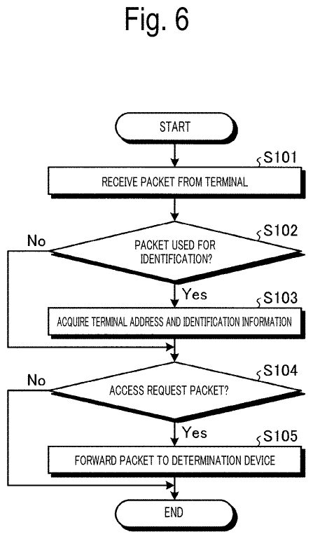

An uplink forwarding process in the gateway device 10 will be described with reference to FIG. 6. FIG. 6 is a flowchart illustrating a flow of an uplink forwarding process in the gateway device according to the first embodiment. Here, the uplink forwarding process is a process in which the gateway device 10 forwards a packet from the network 3 to the network 2.

First, as illustrated in FIG. 6, the gateway device 10 receives a packet from the terminal 20 (step S101). Next, if the received packet is a packet used for identification (step S102, Yes), the gateway device 10 acquires a terminal address and identification information on the basis of the received packet (step S103).

Here, if the received packet is an access request packet (step S104, Yes), the gateway device 10 forwards the packet to the determination device 30 (step S105).

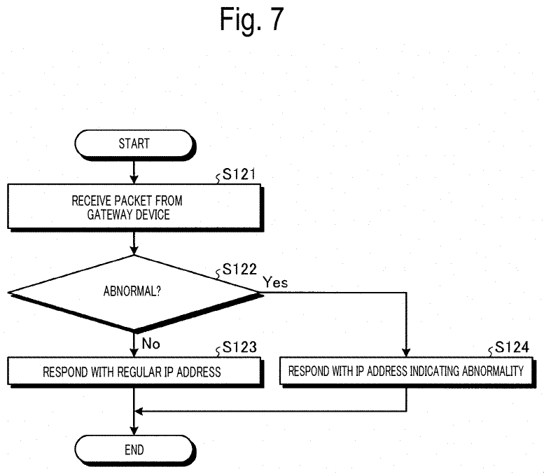

A response process in the determination device 30 will be described with reference to FIG. 7. FIG. 7 is a flowchart illustrating a flow of a response process in the determination device according to the first embodiment. As illustrated in FIG. 7, the determination device 30 first receives a packet from the gateway device 10 (step S121). Here, for example, the determination device 30 receives an access request packet from the gateway device 10.

Next, the determination device 30 determines whether or not the packet is abnormal (step S122). If the packet is not abnormal (step S122, No), the determination device 30 responds with a regular IP address (step S123). On the other hand, if the packet is abnormal (step S122, Yes), the determination device 30 responds with an IP address indicating the abnormality (step S124).

Here, the regular IP address is, for example, an IP address obtained by name resolution when the access request packet is a DNS name resolution request packet. Further, the IP address indicating the abnormality is, for example, a predetermined IP address, which is an IP address that is not used on the network, such as “127.0.0.1”.

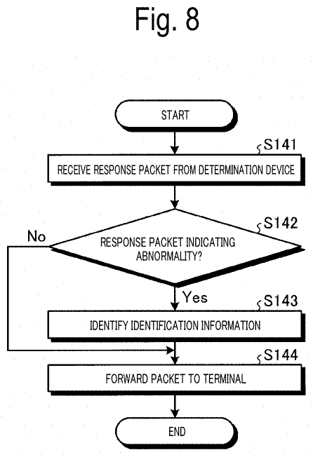

A downlink forwarding process in the gateway device 10 will be described with reference to FIG. 8. FIG. 8 is a flowchart illustrating a flow of a downlink forwarding process in the gateway device according to the first embodiment. Here, the downlink forwarding process is a process in which the gateway device 10 forwards a packet from the network 2 to the network 3.

First, as illustrated in FIG. 8, the gateway device 10 receives a packet from the determination device 30 (step S141). Here, if the received packet is a response packet indicating an abnormality (step S142, Yes), the gateway device 10 identifies the identification information of the terminal that has transmitted the access request packet on the basis of the destination address obtained after translation and the terminal address of the terminal acquired by the acquisition unit (step S143). On the other hand, if the received packet is not a response packet indicating an abnormality (step S142, No), the processing proceeds to the next step in the gateway device 10. Then, the gateway device 10 forwards the packet to the terminal 20 (step S144).

### Effect of First Embodiment

The determination unit 331 determines whether or not the access request packet forwarded by the gateway device 10 is abnormal. The response unit 332 transmits a response packet depending on the determination result by the determination unit 331. The forwarding unit 133 forwards the packet transmitted from the terminal 20 in the network 3 to the determination device 30. The acquisition unit 131 acquires, on the basis of a packet transmitted from a terminal 20 in the network 3, the terminal address and the identification information of the terminal 20 in association with each other. When the determination unit 331 determines that the access request packet is abnormal, the identification unit 132 identifies the destination address of the response packet transmitted by the response unit 332 on the basis of the source address, and further identifies the identification information of the terminal 20 that has transmitted the access request packet on the basis of the terminal address of the terminal 20 that has transmitted the access request packet acquired by the acquisition unit 131.

Thus, in the present embodiment, the identification information of the terminal that has transmitted the access request packet can be identified on the basis of the source address of the access request packet. Therefore, according to the present embodiment, it is possible to easily identify a terminal that has caused an abnormality detected in a network without changing the communication protocol for access request.

### Second Embodiment

A second embodiment will be described. In the first embodiment, the gateway device 10 holds the source address when the access request packet is forwarded. On the other hand, in the second embodiment, the gateway device 10 inserts the source address into the access request packet to be forwarded. Then, the determination device 30 identifies the terminal that has transmitted the access request packet determined to be abnormal on the basis of the source address inserted by the gateway device 10. In the following, description of common parts between the first embodiment and the second embodiment will be omitted as appropriate, and differences between the first embodiment and the second embodiment will be described.

[Configuration of Identification System of Second Embodiment]

A configuration of an identification system 1 according to the second embodiment is the same as that of the first embodiment. That is, as illustrated in FIG. 1, the identification system 1 of the second embodiment includes a gateway device 10 and a determination device 30.

[Configuration of Gateway Device of Second Embodiment]

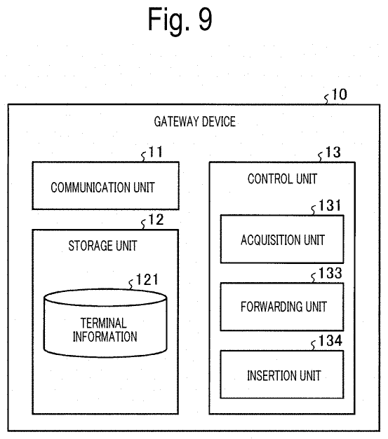

A configuration of the gateway device 10 will be described with reference to FIG. 9. FIG. 9 is a diagram illustrating an example of a configuration of a gateway device according to a second embodiment. As illustrated in FIG. 9, in the second embodiment, the control unit 13 of the gateway device 10 includes an insertion unit 134.

The insertion unit 134 inserts the identification information of the terminal 20 that has transmitted the access request packet acquired by the acquisition unit 131 into the access request packet that has been transmitted from the terminal 20 in the network 3 and is to be forwarded to the determination device 30 by the forwarding unit 133.

[Configuration of Determination Device of Second Embodiment]

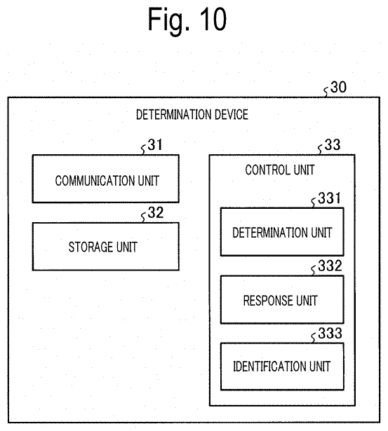

Next, a configuration of the determination device 30 will be described with reference to FIG. 10. FIG. 10 is a diagram illustrating an example of a configuration of a determination device according to the second embodiment. As illustrated in FIG. 10, in the second embodiment, the determination device 30 includes an identification unit 333.

When the determination unit 331 determines that the access request packet is abnormal, the identification unit 333 identifies the identification information inserted into the access request packet by the insertion unit 134 as the identification information of the terminal 20 that has transmitted the access request packet.

### Process According to Second Embodiment

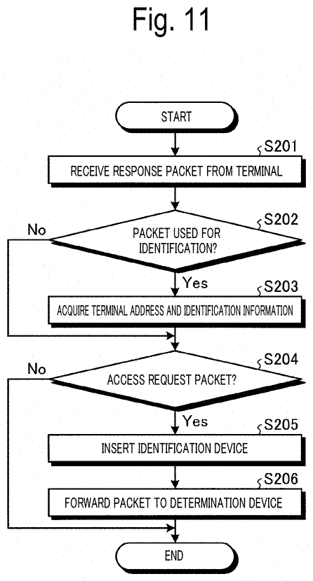

An uplink forwarding process in the gateway device 10 will be described with reference to FIG. 11. FIG. 11 is a flowchart illustrating a flow of an uplink forwarding process in the gateway device according to the second embodiment.

First, as illustrated in FIG. 11, the gateway device 10 receives a packet from the terminal 20 (step S201). Next, if the received packet is a packet used for identification (step S202, Yes), the gateway device 10 acquires a terminal address and identification information on the basis of the received packet (step S203).

Here, if the received packet is an access request packet (step S204, Yes), the gateway device 10 inserts the identification information into the packet (step S205), and forwards the packet to the determination device 30 (step S206). On the other hand, if the received packet is not an access request packet (step S204, No), the processing ends in the gateway device 10.

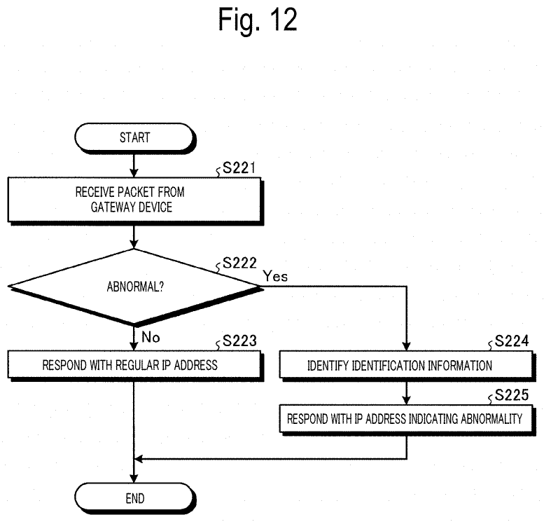

A response process in the determination device 30 will be described with reference to FIG. 12. FIG. 12 is a flowchart illustrating a flow of a response process in the determination device according to the second embodiment. As illustrated in FIG. 12, the determination device 30 first receives a packet from the gateway device 10 (step S221). Here, for example, the determination device 30 receives an access request packet from the gateway device 10.

Next, the determination device 30 determines whether the packet is abnormal (step S222). If the packet is not abnormal (step S222, No), the determination device 30 responds with a regular IP address (step S223). On the other hand, if the packet is abnormal (step S222, Yes), the determination device 30 identifies the identification information inserted into the access request packet (step S224), and responds with an IP address indicating an abnormality (step S225).

### Effect of Second Embodiment

The forwarding unit 133 forwards the access request packet transmitted from the terminal 20 in the network 3 to the determination device 30. The acquisition unit 131 acquires, on the basis of a packet transmitted from a terminal 20 in the network 3, the terminal address and the identification information of the terminal 20 in association with each other. The insertion unit 134 inserts the identification information of the terminal 20 that has transmitted the access request packet acquired by the acquisition unit 131 into the access request packet that has been transmitted from the terminal 20 in the network 3 and is to be forwarded to the determination device 30 by the forwarding unit 133. The determination unit 331 determines whether or not the access request packet forwarded by the gateway device 10 is abnormal. The response unit 332 transmits a response packet depending on the determination result by the determination unit 331. When the determination unit 331 determines that the access request packet is abnormal, the identification unit 333 identifies the identification information inserted into the access request packet by the insertion unit 134 as the identification information of the terminal 20 that has transmitted the access request packet.

Thus, in the present embodiment, the gateway device inserts, into an access request packet, the identification information of a terminal that is the transmission source of the access request packet, thereby making it possible for the determination device 30 to identify the identification information. Therefore, according to the present embodiment, it is possible to easily identify a terminal that has caused an abnormality detected in the network and also for the identification device to centrally collect pieces of identification information of abnormal terminals.

### Third Embodiment

A third embodiment will be described. In the first embodiment and the second embodiment described above, the gateway device 10 or the determination device 30 identifies the identification information of a terminal that has transmitted an access request packet determined to be abnormal. In contrast, in the third embodiment, identification information is identified by a management device 40. In the following, description of common parts among the embodiments will be omitted as appropriate, and differences between the third embodiment and the other embodiments will be described.

[Configuration of Identification System of Third Embodiment]

In the third embodiment, the management device 40 identifies the identification information of a terminal that has transmitted an access request packet determined to be abnormal on the basis of information acquired from a gateway device 10 and a determination device 30.

[Configuration of Gateway Device of Third Embodiment]

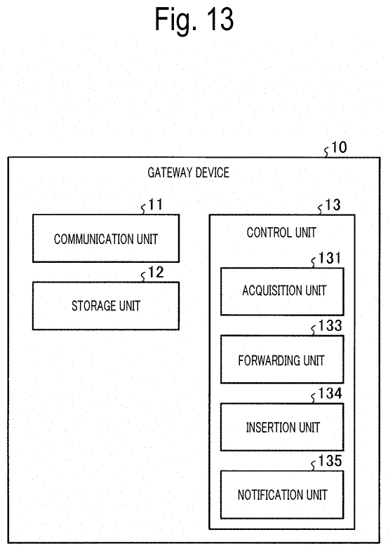

A configuration of the gateway device 10 will be described with reference to FIG. 13. FIG. 13 is a diagram illustrating an example of a configuration of a gateway device according to a third embodiment. As illustrated in FIG. 13, in the third embodiment, the control unit 13 of the gateway device 10 includes a notification unit 135.

The notification unit 135 notifies the management device 40 of a terminal address and identification information of a terminal 20 that has transmitted an access request packet acquired by the acquisition unit 131. Note that the terminal address and the identification information are acquired by the acquisition unit 131.

[Configuration of Determination Device of Third Embodiment]

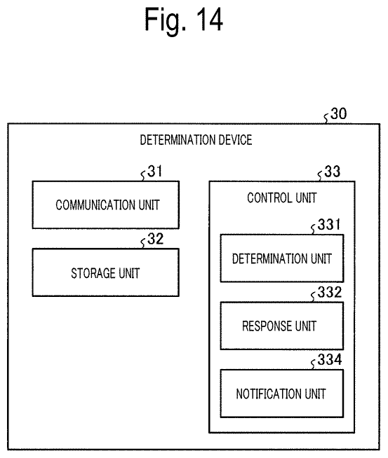

Next, a configuration of the determination device 30 will be described with reference to FIG. 14. FIG. 14 is a diagram illustrating an example of a configuration of a determination device according to the third embodiment. As illustrated in FIG. 14, in the third embodiment, the determination device 30 includes a notification unit 334.

When the determination unit 331 determines that the access request packet is abnormal, the notification unit 334 notifies the management device 40 of the terminal address inserted into the access request packet by the insertion unit 134 and the source address of the access request packet.

[Configuration of Management Device of Third Embodiment]

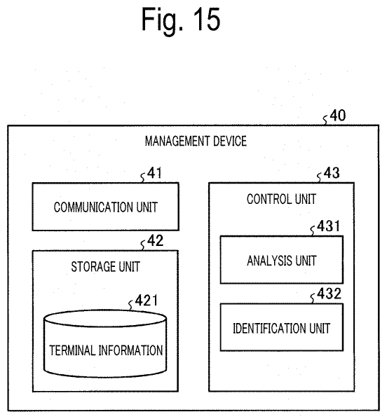

Next, a configuration of the management device 40 will be described with reference to FIG. 15. FIG. 15 is a diagram illustrating an example of the configuration of the management device according to the third embodiment. As illustrated in FIG. 15, the storage unit 42 stores terminal information 421. Further, the control unit 43 includes an identification unit 432.

The terminal information 421 is the same information as the terminal information 121 in the first embodiment. Further, the terminal information 421 is notified by the notification unit 135 of the gateway device 10. Further, the management device 40 stores a piece of terminal information 421 for each of a plurality of gateway devices 10. In this case, the management device 40 may acquire, on the basis of the address of the gateway device 10, the corresponding terminal information 421. Further, the source address of the packet may be translated into the address of the gateway device 10 that has performed the forwarding.

When the determination unit 331 determines that the access request packet is abnormal, the identification unit 432 identifies the identification information of the terminal 20 that has transmitted the access request packet on the basis of the terminal address and the source address notified by the notification unit 334, and the terminal address and the identification information notified by the notification unit 135. Note that the identification unit 432 can acquire the terminal information 421 of the corresponding gateway device 10 from the source address.

### Process According to Third Embodiment

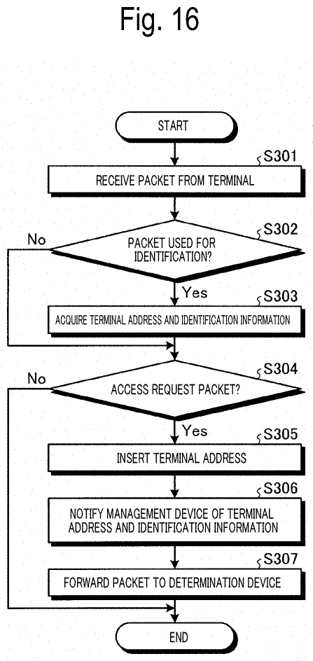

An uplink forwarding process in the gateway device 10 will be described with reference to FIG. 16. FIG. 16 is a flowchart illustrating a flow of an uplink forwarding process in the gateway device according to the third embodiment.

First, as illustrated in FIG. 16, the gateway device 10 receives a packet from the terminal 20 (step S301). Next, if the received packet is a packet used for identification (step S302, Yes), the gateway device 10 acquires a terminal address and identification information on the basis of the received packet (step S303).

Here, if the received packet is an access request packet (step S304, Yes), the gateway device 10 inserts the terminal address into the packet (step S305), notifies the management device 40 of the terminal address and the identification information (step S306), and forwards the packet to the determination device 30 (step S307). On the other hand, if the received packet is not an access request packet (step S304, No), the processing ends in the gateway device 10.

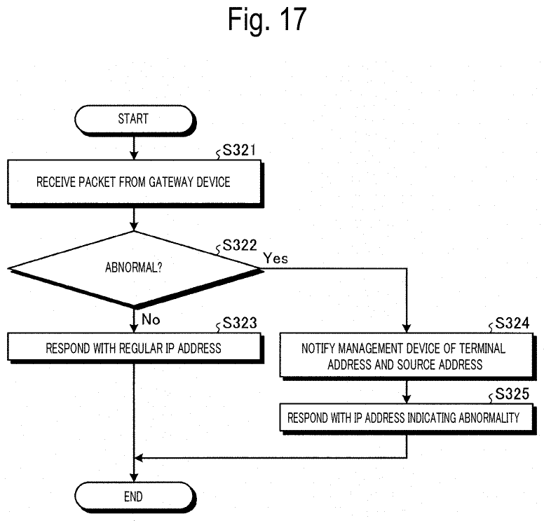

A response process in the determination device 30 will be described with reference to FIG. 17. FIG. 17 is a flowchart illustrating a flow of a response process in the determination device according to the third embodiment. As illustrated in FIG. 17, the determination device 30 first receives a packet from the gateway device 10 (step S321). Here, for example, the determination device 30 receives an access request packet from the gateway device 10.

Next, the determination device 30 determines whether the packet is abnormal (step S322). If the packet is not abnormal (step S322, No), the determination device 30 responds with a regular IP address (step S323). On the other hand, if the packet is abnormal (step S322, Yes), the terminal address and the source address inserted into the access request packet are notified to the management device 40 (step S324). Then, the determination device 30 responds with an IP address indicating the abnormality (step S325).

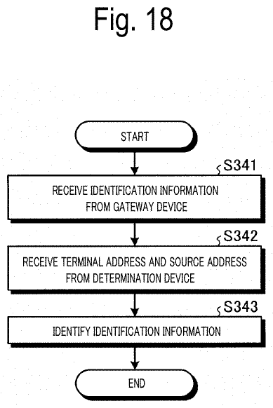

An identification process in the management device 40 will be described with reference to FIG. 18. FIG. 18 is a flowchart illustrating a flow of the identification process in the management device according to the third embodiment. As illustrated in FIG. 18, the management device 40 first receives identification information from the gateway device 10 (step S341). Next, the management device 40 receives terminal address and source address from the determination device 30 (step S342). Then, the management device 40 identifies the identification information from the received information (step S343).

### Effect of Third Embodiment

The forwarding unit 133 forwards the packet transmitted from the terminal 20 in the network 3 to the determination device 30. The acquisition unit 131 acquires, on the basis of a packet transmitted from a terminal 20 in the network 3, the terminal address and the identification information of the terminal 20 in association with each other. The insertion unit 134 inserts the terminal address of the terminal 20 that has transmitted the access request packet into the access request packet that has been transmitted from the terminal 20 in the network 3 and is to be forwarded to the determination device 30 by the forwarding unit 133. The notification unit 135 notifies the management device 40 of a terminal address and identification information of a terminal 20 that has transmitted an access request packet acquired by the acquisition unit 131. The determination unit 331 determines whether or not the access request packet forwarded by the gateway device 10 is abnormal. The response unit 332 transmits a response packet depending on the determination result by the determination unit 331. When the determination unit 331 determines that the access request packet is abnormal, the notification unit 334 notifies the management device 40 of the terminal address inserted into the access request packet by the insertion unit 134 and the source address of the access request packet. When the determination unit 331 determines that the access request packet is abnormal, the identification unit 432 identifies the identification information of the terminal 20 that has transmitted the access request packet on the basis of the terminal address and the source address notified by the notification unit 334, and the terminal address and the identification information notified by the notification unit 135.

Thus, in the present embodiment, the gateway device inserts, into an access request packet, the fixed-length address information of a terminal that is the transmission source of the access request packet, thereby making it possible for the management device 40 to identify the identification information. Therefore, according to the present embodiment, no more than changes in the communication protocol for access request make it possible to easily identify a terminal that has caused an abnormality detected in the network and also for the management device to centrally collect pieces of identification information of abnormal terminals.

### Fourth Embodiment

A fourth embodiment will be described. The fourth embodiment is different from the third embodiment in that a gateway device 10 forwards a packet to a management device 40. In the fourth embodiment, the management device 40 directly acquires identification information from a packet.

[Configuration of Identification System of Fourth Embodiment]

A configuration of an identification system 1 of the fourth embodiment is the same as that of the third embodiment. That is, as illustrated in FIG. 12, the identification system 1 of the fourth embodiment includes the gateway device 10, a determination device 30, and the management device 40.

[Configuration of Management Device of Fourth Embodiment]

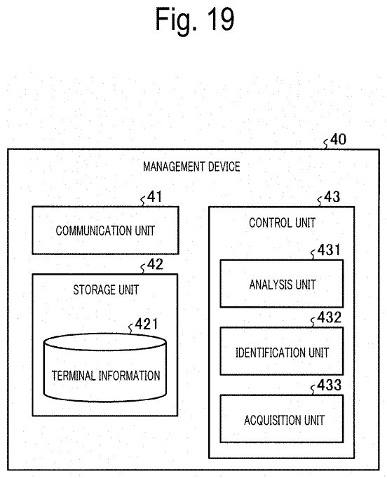

A configuration of the management device 40 will be described with reference to FIG. 19. FIG. 19 is a diagram illustrating an example of the configuration of the management device according to a fourth embodiment. As illustrated in FIG. 19, in the fourth embodiment, the control unit 43 of the management device 40 includes an acquisition unit 433.

The notification unit 135 of the gateway device 10 notifies the management device 40 of a terminal address of a terminal 20 that has transmitted an access request packet acquired by the acquisition unit 131. The notification unit 135 also notifies the management device 40 of the access request packet. Here, the packet notified by the notification unit 135 to the management device 40 may be the packet itself, or may be limited to information necessary for generating identification information from the packet.

The acquisition unit 433 of the management device 40 acquires, on the basis of the packet and the terminal address notified by the notification unit 135, the terminal address and the identification information of the terminal 20 that has transmitted the packet in association with each other.

At this time, when the determination unit 331 determines that the access request packet is abnormal, the identification unit 432 identifies the identification information of the terminal 20 that has transmitted the access request packet on the basis of the terminal address and the source address notified by the notification unit 334, and the identification information acquired by the acquisition unit 433.

### Process According to Fourth Embodiment

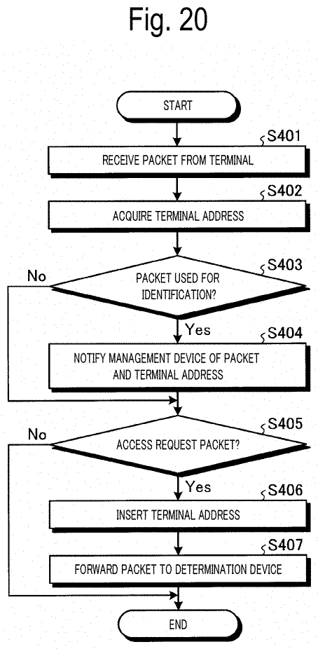

An uplink forwarding process in the gateway device 10 will be described with reference to FIG. 20. FIG. 20 is a flowchart illustrating a flow of the uplink forwarding process in the gateway device according to the fourth embodiment.

First, as illustrated in FIG. 20, the gateway device 10 receives a packet from the terminal 20 (step S401). Next, the gateway device 10 acquires a terminal address (step S402). If the received packet is a packet used for identification (step S403, Yes), the gateway device 10 notifies the management device 40 of the received packet and the terminal address (step S404).

Here, if the received packet is an access request packet (step S405 Yes), the gateway device 10 inserts the terminal address into the packet (step S406), and forwards the packet to the determination device 30 (step S407). On the other hand, if the received packet is not an access request packet (step S405, No), the processing ends in the gateway device 10.

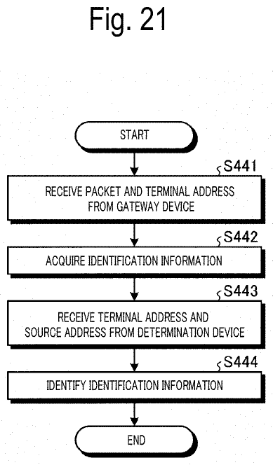

An identification process in the management device 40 will be described with reference to FIG. 21. FIG. 21 is a flowchart illustrating a flow of the identification process in the management device according to the fourth embodiment. As illustrated in FIG. 21, the management device 40 first receives a packet and a terminal address from the gateway device 10 (step S441). Next, the management device 40 acquires the identification information of the terminal that has transmitted the packet on the basis of the received packet (step S442).

Here, the management device 40 receives a terminal address and a source address from the determination device 30 (step S443). Then, the management device 40 identifies the identification information from the received information (step S444).

### Effect of Fourth Embodiment

The forwarding unit 133 forwards the packet transmitted from the terminal 20 in the network 3 to the determination device 30 and the management device 40. The acquisition unit 131 acquires, on the basis of a packet transmitted from a terminal 20 in the network 3, the terminal address of the terminal 20. The insertion unit 134 inserts the terminal address of the terminal 20 that has transmitted the access request packet into the access request packet that has been transmitted from the terminal 20 in the network 3 and is to be forwarded to the network 2 by the forwarding unit 133. The determination unit 331 determines whether or not the access request packet forwarded by the gateway device 10 is abnormal. The response unit 332 transmits a response packet depending on the determination result by the determination unit 331. When the determination unit 331 determines that the access request packet is abnormal, the notification unit 334 notifies the management device 40 of the terminal address inserted into the access request packet by the insertion unit 134 and the source address of the access request packet. The acquisition unit 433 acquires, on the basis of the packet forwarded by the forwarding unit 133, the terminal address and the identification information of the terminal 20 that has transmitted the packet in association with each other. When the determination unit 331 determines that the access request packet is abnormal, the identification unit 432 identifies the identification information of the terminal 20 that has transmitted the access request packet on the basis of the terminal address and the source address notified by the notification unit 334, and the identification information acquired by the acquisition unit 433.

Thus, in the present embodiment, the gateway device inserts, into an access request packet, the fixed-length address information of a terminal that is the transmission source of the access request packet, thereby making it possible for the management device 40 to acquire and identify the identification information. Therefore, according to the present embodiment, no more than changes in the communication protocol for access request make it possible to easily identify a terminal that has caused an abnormality detected in the network and also for the management device to centrally collect pieces of identification information of abnormal terminals.

### OTHER EMBODIMENTS

The identification unit 132, the identification unit 333, or the identification unit 432 can notify, to the user of the terminal 20 identified by the identified identification information, that the access request packet transmitted from the terminal 20 is determined to be abnormal. In the embodiments, such a notification is practicable because the terminal 20 that has transmitted an abnormal access request packet has been identified as described above.

Also, the determination device 30 can serve as a DNS server, the access request packet can serve as a name resolution request packet based on the DNS protocol, and the response packet by the determination device 30 can serve as a name resolution response packet based on the DNS protocol.

[System Configuration, Etc.]

Further, each component of each device illustrated is a functional concept and does not necessarily need to be physically configured as illustrated. In other words, a specific form of distribution and integration of the devices is not limited to the illustrated one, and all or a part thereof may be functionally or physically distributed or integrated on any unit basis in accordance with various loads and usage conditions. Further, all or any part of each processing function performed by each device can be implemented by a CPU and a program analyzed and executed by the CPU, or can be implemented as hardware by wired logic.

Further, in the embodiment in which identification information is identified by the determination device 30, the analysis unit 431 of the management device 40 can perform the analysis on the basis of the identification information identified by the determination device 30. Further, in the embodiment in which identification information is identified by the determination device 30, the analysis unit 431 can perform the analysis on the basis of the identification information identified by the management device 40.

Further, among the processes described in the embodiments, all or a part of the processes described as being performed automatically can be manually performed, or all or apart of the processes described as being performed manually can be performed automatically by a known method. In addition, the processing procedures, control procedures, specific names, and information including various data and parameters described in the above documents and drawings can be arbitrarily changed unless otherwise specified.

[Program]

As one embodiment, the determination device 30 can be implemented by installing a determination program for performing the above determination as package software or online software on a desired computer. For example, by causing an information processing device to execute the above determination program, the information processing device can function as the determination device 30. The information processing device referred to here includes a desktop or laptop personal computer. The information processing device also includes a mobile communication terminal such as a smartphone, a mobile phone, and a PHS (Personal Handy-phone System), and a slate terminal such as a PDA (Personal Digital Assistant).

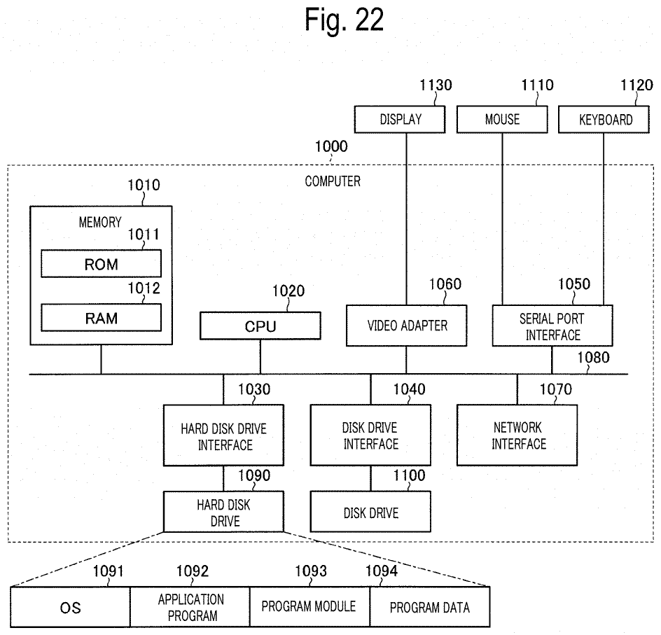

FIG. 22 is a diagram illustrating an example of a computer that functions as the gateway device, the determination device, or the management device to execute an identification program. A computer 1000 includes, for example, a memory 1010 and a CPU 1020. The computer 1000 includes a hard disk drive interface 1030, a disk drive interface 1040, a serial port interface 1050, a video adapter 1060, and a network interface 1070. These components are connected by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. Accordingly, a program that defines each process in the gateway device 10 or the determination device 30 is implemented as the program module 1093 in which codes executable by a computer are described. The program module 1093 is stored in, for example, the hard disk drive 1090. For example, the program module 1093 for executing processes corresponding to the functional configuration of the gateway device 10 or the determination device 30 is stored in the hard disk drive 1090. Note that the hard disk drive 1090 may be replaced with an SSD.

Further, setting data used in the processes in the above-described embodiments is stored as the program data 1094 in, for example, the memory 1010 or the hard disk drive 1090. Then, the CPU 1020 loads the program module 1093 and the program data 1094 stored in the memory 1010 and the hard disk drive 1090 into the RAM 1012 as necessary, and executes the processes in the above-described embodiments.

Note that the program module 1093 and the program data 1094 are not limited to being stored in the hard disk drive 1090, but may be stored in, for example, a removable storage medium and read out by the CPU 1020 via the disk drive 1100 or the like. Alternatively, the program module 1093 and the program data 1094 may be stored in another computer connected via a network (LAN (Local Area Network), WAN (Wide Area Network), or the like). Then, the program module 1093 and the program data 1094 may be read from the other computer by the CPU 1020 via the network interface 1070.

### REFERENCE SIGNS LIST

1 Identification system
10 Gateway device
20 Terminal
30 Determination device
40 Management device
11, 31, 41 Communication unit
12, 32, 42 Storage unit
13, 33, 43 Control unit
121, 421 Terminal information
122 Request packet information
131, 433 Acquisition unit
132, 333, 432 Identification unit
133 Forwarding unit
134 Insertion unit
135 Notification unit
331 Determination unit
332 Response unit

1. An identification system comprising:
a gateway device connected to a first network and a second network; and
a determination device connected to the first network, wherein the determination device includes:
determination circuitry that determines whether an access request packet forwarded by the gateway device is abnormal; and
response circuitry that transmits a response packet depending on a determination result by the determination circuitry,
wherein the gateway device includes:
forwarding circuitry that forwards, to the determination device, the access request packet transmitted from a terminal in the second network, and forwards, to the terminal, a response packet transmitted by the response circuitry,
acquisition circuitry that acquires, on the basis of a packet transmitted from a terminal in the second network, a terminal address and identification information of the terminal in association with each other, and
identification circuitry that identifies, when the determination circuitry determines that the access request packet is abnormal, the identification information of the terminal that has transmitted the access request packet on the basis of the response packet transmitted by the response circuitry and the terminal address, of the terminal that has transmitted the access request packet, acquired by the acquisition circuitry.

2. An identification system comprising:
a gateway device connected to a first network and a second network; and
a determination device connected to the first network,
wherein the gateway device includes:
forwarding circuitry that forwards an access request packet transmitted from a terminal in the second network to the determination device,
acquisition circuitry that acquires, on the basis of a packet transmitted from a terminal in the second network, a terminal address and identification information of the terminal in association with each other, and
insertion circuitry that inserts identification information of the terminal that has transmitted the access request packet acquired by the acquisition circuitry into the access request packet that has been transmitted from the terminal in the second network and is to be forwarded to the determination device by the forwarding circuitry,
wherein the determination device includes:
determination circuitry that determines whether the access request packet forwarded by the gateway device is abnormal,
response circuitry that transmits a response packet depending on a determination result by the determination circuitry, and
identification circuitry that identifies, when the determination circuitry determines that the access request packet is abnormal, the identification information inserted into the access request packet by the insertion circuitry as the identification information of the terminal that has transmitted the access request packet.

3. An identification system comprising:
a gateway device connected to a first network and a second network;
a determination device connected to the first network; and
a management device connected to the first network,
wherein the gateway device includes:
forwarding circuitry that forwards an access request packet transmitted from a terminal in the second network to the determination device,
acquisition circuitry that acquires, on the basis of a packet transmitted from a terminal in the second network, a terminal address and identification information of the terminal in association with each other,
insertion circuitry that inserts a terminal address of the terminal that has transmitted the access request packet into the access request packet that has been transmitted from the terminal in the second network and is to be forwarded to the determination device by the forwarding circuitry, and
first notification circuitry that notifies the management device of the terminal address and the identification information of the terminal that has transmitted an access request packet acquired by the acquisition circuitry,
wherein the determination device includes:
determination circuitry that determines whether the access request packet forwarded by the gateway device is abnormal,
response circuitry that transmits a response packet depending on a determination result by the determination circuitry, and
second notification circuitry that notifies, when the determination circuitry determines that the access request packet is abnormal, the management device of the terminal address inserted into the access request packet by the insertion circuitry and a source address of the access request packet, and
wherein the management device includes:
identification circuitry that identifies, when the determination circuitry determines that the access request packet is abnormal, the identification information of the terminal that has transmitted the access request packet on the basis of the terminal address and the source address notified by the second notification circuitry, and the terminal address and the identification information notified by the first notification circuitry.

4. An identification system comprising:
a gateway device connected to a first network and a second network;
a determination device connected to the first network; and
a management device connected to the first network,
wherein the gateway device includes:
forwarding circuitry that forwards an access request packet transmitted from a terminal in the second network to the determination device,
second notification circuitry that notifies the management device of a packet transmitted from a terminal of the second network and a terminal address of the terminal, and
insertion circuitry that inserts a terminal address of the terminal that has transmitted the access request packet into the access request packet that has been transmitted from the terminal in the second network and is to be forwarded to the first network by the forwarding circuitry, and
wherein the determination device includes:
determination circuitry that determines whether the access request packet forwarded by the gateway device is abnormal,
response circuitry that transmits a response packet depending on a determination result by the determination circuitry, and
third notification circuitry notifies, when the determination circuitry determines that the access request packet is abnormal, the management device of the terminal address inserted into the access request packet by the insertion circuitry and a source address of the access request packet, and
wherein the management device includes:
acquisition circuitry that acquires, on the basis of the packet and the terminal address notified by the second notification circuitry, the terminal address and the identification information of the terminal that has transmitted the packet in association with each other, and
identification circuitry that identifies, when the determination circuitry determines that the access request packet is abnormal, the identification information of the terminal that has transmitted the access request packet on the basis of the terminal address and the source address notified by the third notification circuitry, and the identification information acquired by the acquisition circuitry.

5. The identification system according to claim 1, wherein the identification circuitry notifies, to a user of the terminal identified by the identified identification information, that the access request packet transmitted from the terminal is determined to be abnormal.

6. The identification system according to claim 1, further comprising an analysis circuitry installed in the first network, wherein the analysis circuitry analyzes a tendency of the terminal that has transmitted the access request packet determined to be abnormal on the basis of the identification information identified by the identification circuitry.

7. The identification system according to claim 1, wherein the determination device is a DNS (Domain Name System) server, the access request packet is a name resolution request packet based on a DNS protocol, and the response packet is a name resolution response packet based on the DNS protocol.

8. An identification method performed in an identification system that includes a gateway device connected to a first network and a second network, and a determination device connected to the first network, the identification method comprising:
acquiring, by the gateway device, on the basis of an access request packet transmitted from a terminal in the second network, a terminal address and identification information of the terminal in association with each other;
forwarding, by the gateway device, the access request packet to the determination device;
determining, whether the access request packet forwarded by the gateway device is abnormal;
transmitting a response packet depending on a determination result in the determination; and
identifying, by the gateway device, when the access request packet is determined to be abnormal in the determination, the identification information of the terminal that has transmitted the access request packet on the basis of the response packet transmitted in the transmitting and the terminal address of the terminal acquired in the acquiring.
